(19) United States
(12) Patent Application Publication
(10) Pub. No.: US 2020/0389989 A1
(43) Pub. Date: Dec. 10, 2020

(54) LAY-FLAT LID WITH HIDDEN DUAL HINGE

(71) Applicants: Norman R. Byrne, Ada, MI (US); Steven K. Meek, Rockford, MI (US)

(72) Inventors: Norman R. Byrne, Ada, MI (US); Steven K. Meek, Rockford, MI (US)

(21) Appl. No.: 16/895,703

(22) Filed: Jun. 8, 2020

Related U.S. Application Data
(60) Provisional application No. 62/859,085, filed on Jun. 8, 2019.

(51) Int. Cl. H05K 5/02; H02G 3/08; H05K 5/03

(52) U.S. Cl. CPC H05K 5/0226; H05K 5/03; H02G 3/08

(57) ABSTRACT

A dual-hinged lid assembly includes a lid pivotably coupled to a frame by a pair of hinge portions that enable the lid to pivot about two different axes, and to pivot open until lying flat against, or in close proximity to, a portion of the frame to which the lid is coupled. A first hinge portion is pivotably coupled to the lid, and a second hinge portion is located at the frame and is coupled to the first hinge portion. The first hinge portion cooperates with the lid to define a first pivot axis, and the first hinge portion cooperates with the second hinge portion to define a second pivot axis that is spaced from the first pivot axis.

### CROSS REFERENCE TO RELATED APPLICATION

The present application claims the benefit of U.S. provisional application Ser. No. 62/859,085, filed Jun. 8, 2019, which is hereby incorporated by reference in its entirety.

### FIELD OF THE INVENTION

The present invention relates to doors for housings, such as housings containing electrical power and/or data outlet for use in work areas and the like.

### BACKGROUND OF THE INVENTION

Electrical power and/or data systems are commonly provided in work areas, such as at or in work tables and desks, conference tables, work area dividers, and the like. Such systems typically provide one or more high voltage AC power outlets, and in some cases provide one or more low voltage DC power outlets and/or electronic data or communications receptacles, or various combinations of these.

### SUMMARY OF THE INVENTION

The present invention provides a dual-hinged lid assembly having a lid that is pivotable relative to a frame about two different pivot axes, and may pivot by about 180 degrees from a fully closed position to a fully open position. The frame defines an opening in which the lid is mounted, with the lid coupled to the frame by first and second hinge pieces that cooperate to form a first hinge portion defining a first pivot axis and a second hinge portion defining a second pivot axis spaced from the first pivot axis. The first and second hinge pieces are coupled between the frame and the lid, and are arranged so that the first hinge piece cooperates with the lid to define the first pivot axis, and the second hinge piece cooperates with the first hinge piece to define the second pivot axis. The lid is pivotable from the closed position to the fully open position via pivoting movement about both of the first and second pivot axes. Optionally, the lid completely covers and obscures the first and second hinge pieces when the lid is closed.

According to one form of the present invention, a dual-hinged lid assembly includes a frame and a lid pivotably coupled to the frame by two hinge portions. A first of the hinge portions is pivotably coupled to the lid, and a second of the hinge portions is located at the frame and is coupled to the first hinge portion. The first hinge portion cooperates with the lid to define a first pivot axis, and the first hinge portion pivots relative to the second hinge portion to define a second pivot axis spaced from the first pivot axis. As a result, the lid is pivotable from a closed position to an open position via pivoting movement about both of the first and second pivot axes.

In one aspect, both the first hinge portion and the second hinge portion are positioned directly below a portion of the lid in the closed position. Optionally, the first and second hinge portions are both covered by the lid when it is in the closed position.

In another aspect, the lid is pivotable about 180 degrees from the closed position to the open position. For example, the lid may be pivotable by about 90 degrees about the first pivot axis, and the lid and the second hinge portion may be pivotable together by about 90 degrees additional, about the second pivot axis.

In yet another aspect, the second hinge portion includes a pivot stud extending toward the first hinge portion. The second hinge portion also defines a pivot channel that is open toward the first hinge portion. The first hinge portion includes a pivot guide stud that is received in the pivot channel, and further includes a pivot bore that receives the pivot stud. The pivot guide stud traverses along the pivot channel as the second hinge portion pivots relative to the first hinge portion.

In a further aspect, the frame or the second hinge portion includes a fixed pivot-stop element extending beneath the lid. The lid rests atop the pivot-stop element when the lid is in the closed position.

In still another aspect, the frame and the lid are configured to be secured to a housing that supports electrical or data outlets below the lid.

Therefore, the dual-hinged lid assembly of the present invention has a lid that is pivotable relative to a frame about two different pivot axes, and may pivot by as much as about 180 degrees from a fully closed position to a fully open position that fully exposes an opening formed in the frame. The lid may completely cover and obscure the first and second hinge pieces when the lid is closed, such that the lid can substantially fully close the opening in the frame.

These and other objects, advantages, purposes and features of the present invention will become apparent upon review of the following specification in conjunction with the drawings.

### BRIEF DESCRIPTION OF THE DRAWINGS

FIG. 1 is a top perspective view of an upper housing bezel with lay-flat lid in accordance with the present invention, shown in a fully closed position;

FIG. 2 is another top perspective view of the upper housing bezel and lay-flat lid of FIG. 1, shown in a fully open position;

FIG. 3 is an exploded perspective view of the upper housing bezel and lay-flat lid of FIG. 2;

FIGS. 4A and 4B are enlarged exploded perspective views of the dual hinges that couple the lay-flat lid to the upper housing bezel;

FIG. 5 is a bottom perspective view of the upper housing bezel with lay-flat lid shown in the fully closed position, including an enlarged inset view of a dual hinge region;

FIG. 6 is a side sectional view of the upper housing bezel and lay-flat lid of FIG. 5, taken through the dual hinge region;

FIG. 7 is another bottom perspective view of the upper housing bezel with lay-flat lid shown in a 45-degree raised position, including an enlarged inset view of the dual hinge region;

FIG. 8 is a side sectional view of the upper housing bezel and lay-flat lid of FIG. 7, taken through the dual hinge region;

FIG. 9 is another bottom perspective view of the upper housing bezel with lay-flat lid shown in a 90-degree raised position, including an enlarged inset view of the dual hinge region;

FIG. 10 is a side sectional view of the upper housing bezel and lay-flat lid of FIG. 9, taken through the dual hinge region;

FIG. 11 is another bottom perspective view of the upper housing bezel with lay-flat lid shown in a 135-degree raised position, including an enlarged inset view of the dual hinge region;

FIG. 12 is a side sectional view of the upper housing bezel and lay-flat lid of FIG. 11 taken through the dual hinge region;

FIG. 13 is another bottom perspective view of the upper housing bezel with lay-flat lid shown in the fully 180-degree open position, including an enlarged inset view of the dual hinge region; and

FIG. 14 is a side sectional view of the upper housing bezel and lay-flat lid of FIG. 13, taken through the dual hinge region.

### DESCRIPTION OF THE PREFERRED EMBODIMENTS

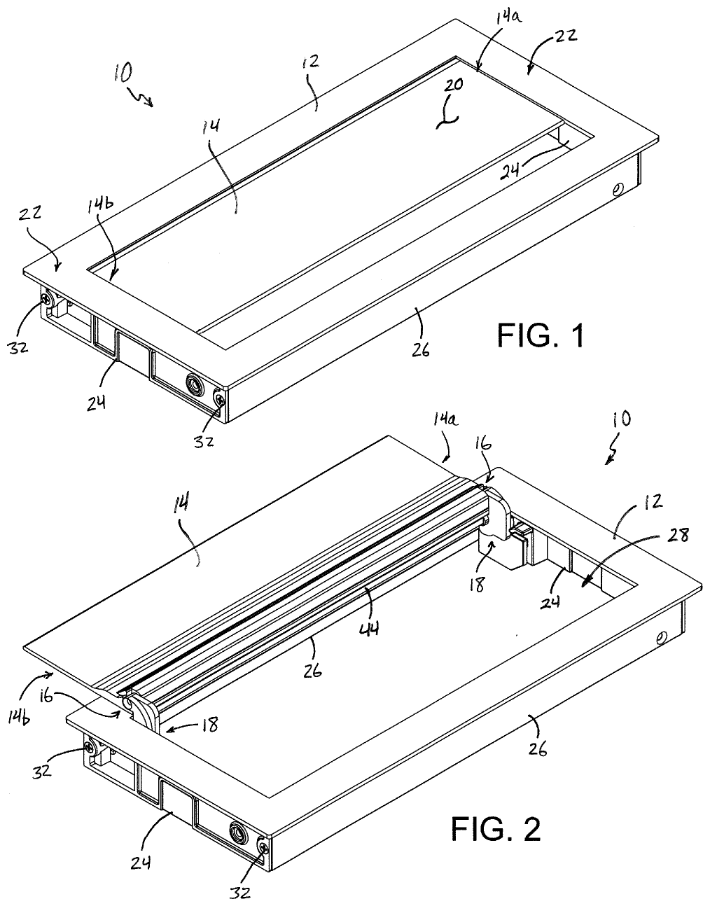

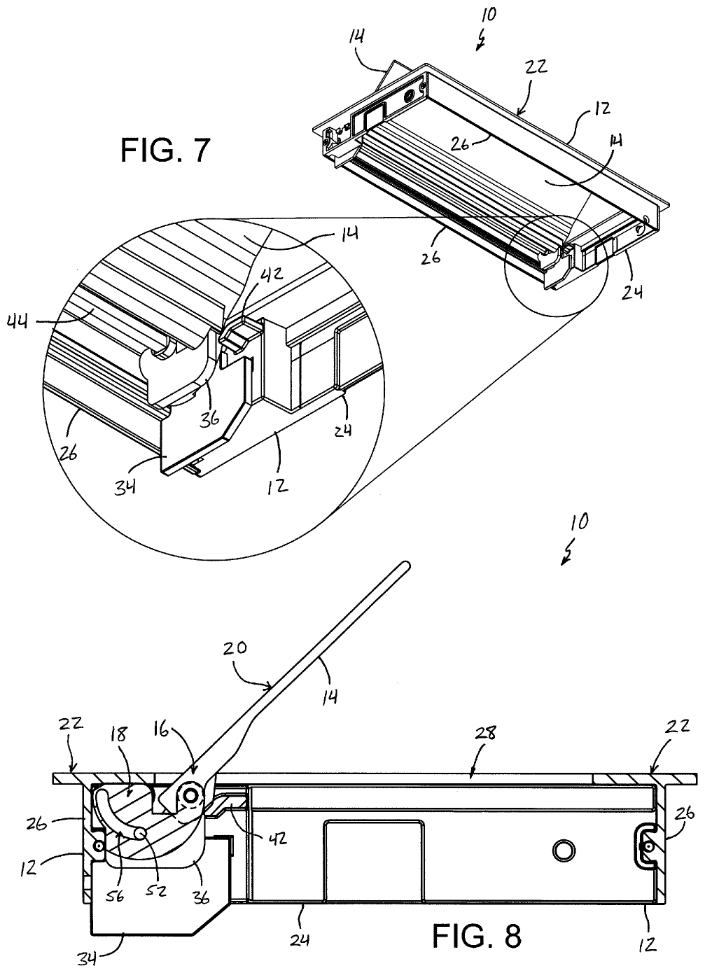

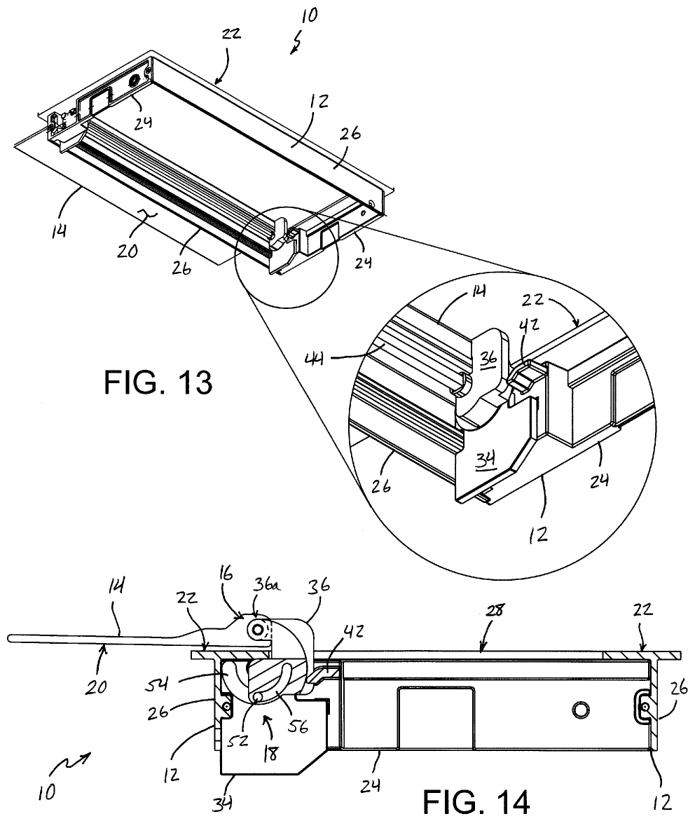

Referring now to the drawings and the illustrative embodiments depicted therein, an upper housing bezel or frame assembly 10 includes a rectangular frame 12 and a dual-hinged lay-flat lid or door 14, such as shown in FIGS. 1 and 2. The lid 14 is positionable from a fully-closed position (FIGS. 1, 5, and 6) to a vertically-raised position (FIGS. 7 and 8) about a first hinge portion 16. The lid 14 is further positionable from the vertically-raised position of FIGS. 7 and 8 to a lay-flat 180-degree open position (FIGS. 2, 13, and 14) about a second hinge portion 18, as will be described in more detail below. The first and second hinge portions 16, 18 are configured so that they are hidden from view when the lid 14 is fully closed, in which a top surface 20 of the lid is substantially parallel to an upper bezel portion 22 of the rectangular frame 12. Thus, the upper housing bezel assembly 10 can be particularly useful for selectively concealing electrical outlet assemblies that are recessed within work surfaces such as tables, desks, countertops, or other furniture articles or even walls or room dividers. The lid 14 may be fully opened to the 180-degree position to provide full access to the interior of a housing (not shown) to which the upper housing bezel assembly 10 is attached, without the lid 14 being positioned significantly above a work surface to which the upper housing bezel assembly 10 is attached. This permits a substantially unobstructed view of nearly the entire work surface, and of articles positioned thereon, regardless of whether the lid 14 is fully open or fully closed.

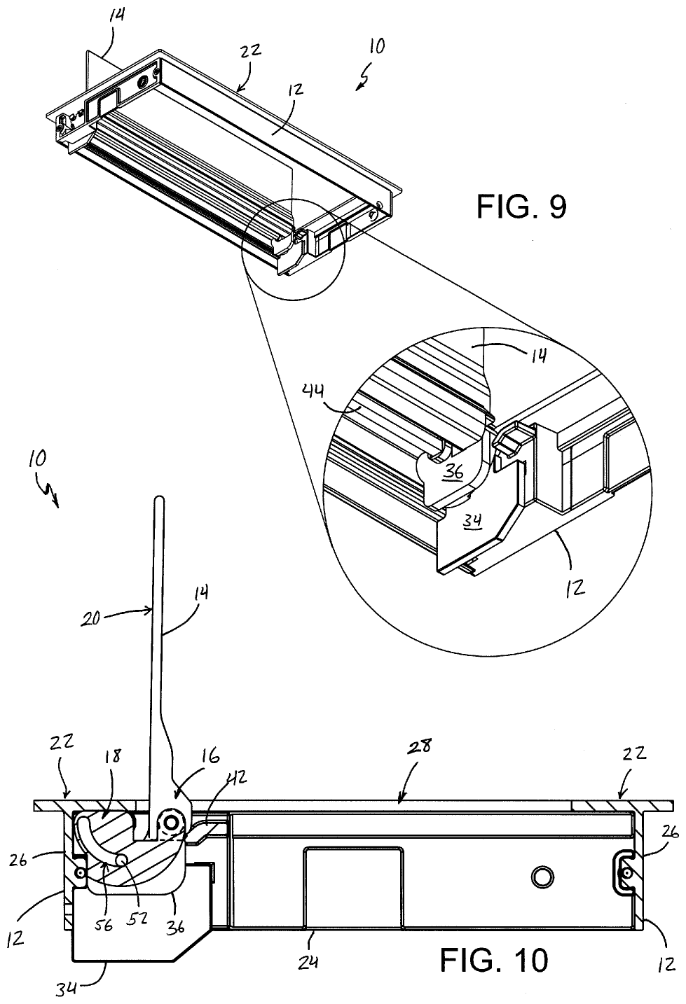

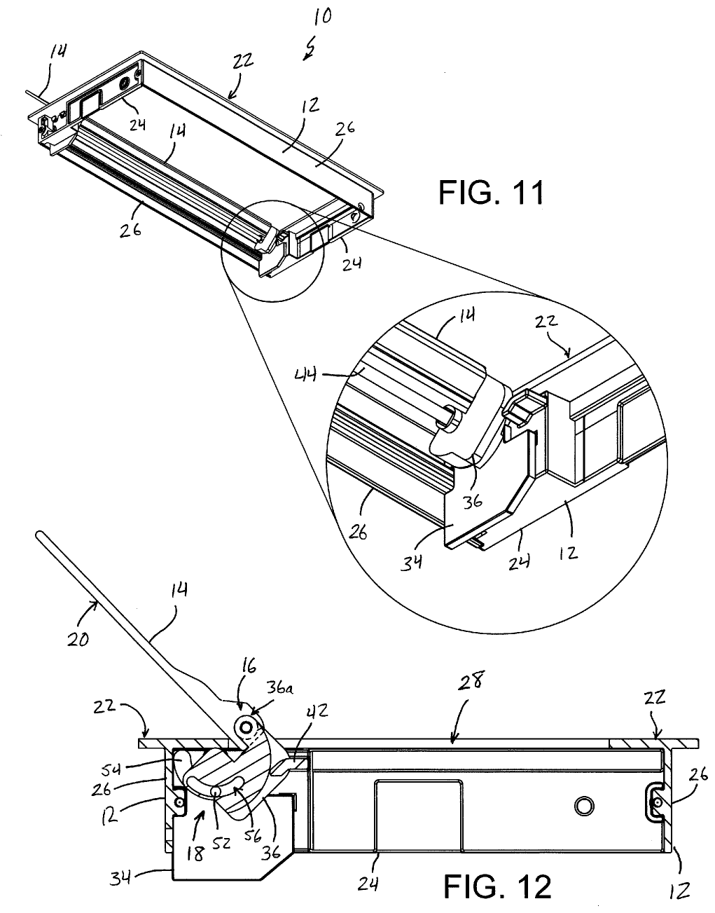

The first hinge portion 16 permits the lid to be left in the vertically-raised position of FIGS. 7 and 8, and may provide limited frictional resistance to pivoting movement such that the lid may also be left fixed in a non-vertical open position such as the 45-degree open position of FIGS. 7 and 8. The second hinge portion 18 generally does not begin to move until the lid begins to move further open beyond the vertically-raised position of FIGS. 9 and 10, during which movement the lid 14 does not move any further relative to the first hinge portion 16. The second hinge portion 18 may support the lid 14 in a slightly elevated position relative to the upper bezel portion 22, in which the lid's top surface 20 may also be substantially parallel to the upper bezel portion, when the lid 14 is in the fully-open 180-degree position of FIGS. 2, 13, and 14. The second hinge portion 18 may provide limited frictional resistance to pivoting movement such that the lid 14 may be left fixed in a non-vertical open position, such as the 135-degree open position of FIGS. 11 and 12.

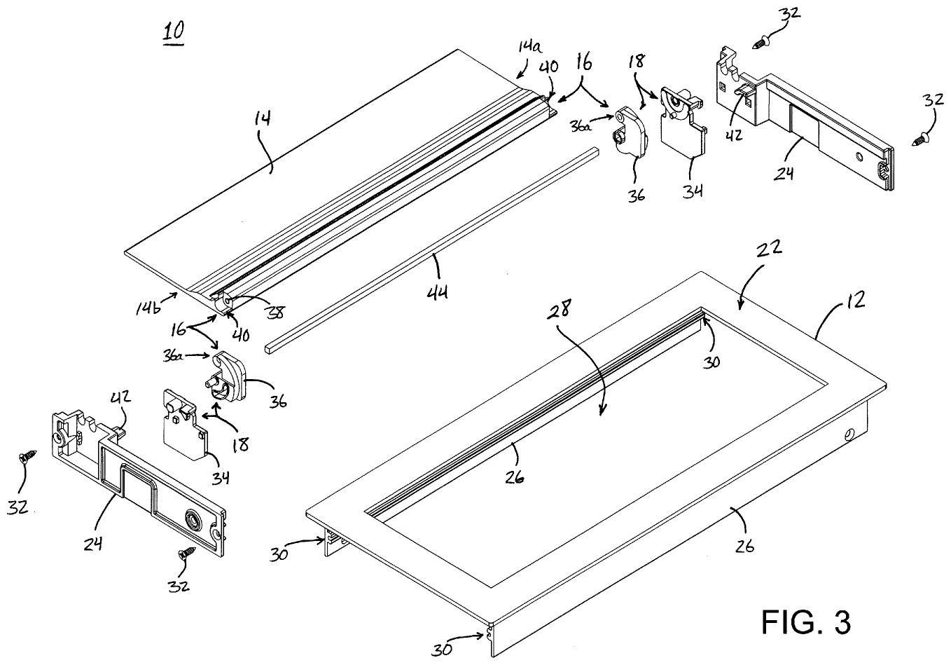

First hinge portion 16 and second hinge portion 18 are used to pivotably secure the lid 14 to a pair of downwardly-extending end walls 24 that are secured between respective ends of a pair of downwardly-extending side walls 26, such as shown in FIGS. 1-3. Side walls 26 may be unitarily formed with the upper bezel portion 22 in an extrusion process, with a top opening 28, the ends of each side wall 26, and the ends of the bezel portion 22 machined to their final dimensions in subsequent operations. It will be appreciated that the side walls 26 may alternatively be formed separately from the upper bezel portion 22 and later secured to the upper bezel portion with mechanical fasteners, welds, brackets, or other suitable means. Screw bosses 30 are formed lengthwise along inwardly-facing surfaces of the side walls 26 (FIG. 3) and receive self-tapping threaded screws 32 that pass through opposite ends of the end walls 24 to secure the end walls 24 to the side walls 26 and the upper bezel portion 22 to form the rectangular frame 12. The rectangular frame 12 may then be secured to the upper end region of any desired housing, such as an electrical power or electronic data housing that supports one or more receptacles for conveying electrical power and/or electronic data to other devices, circuits, networks, or infrastructure. Such housings and receptacles are available from Byrne Electrical Specialists, Inc. of Rockford, Mich., and are more fully described and illustrated in commonly-owned U.S. Pat. Nos. 10,673,191; 9,312,673; 8,444,432; and 8,480,429, all of which are hereby incorporated herein by reference in their entireties.

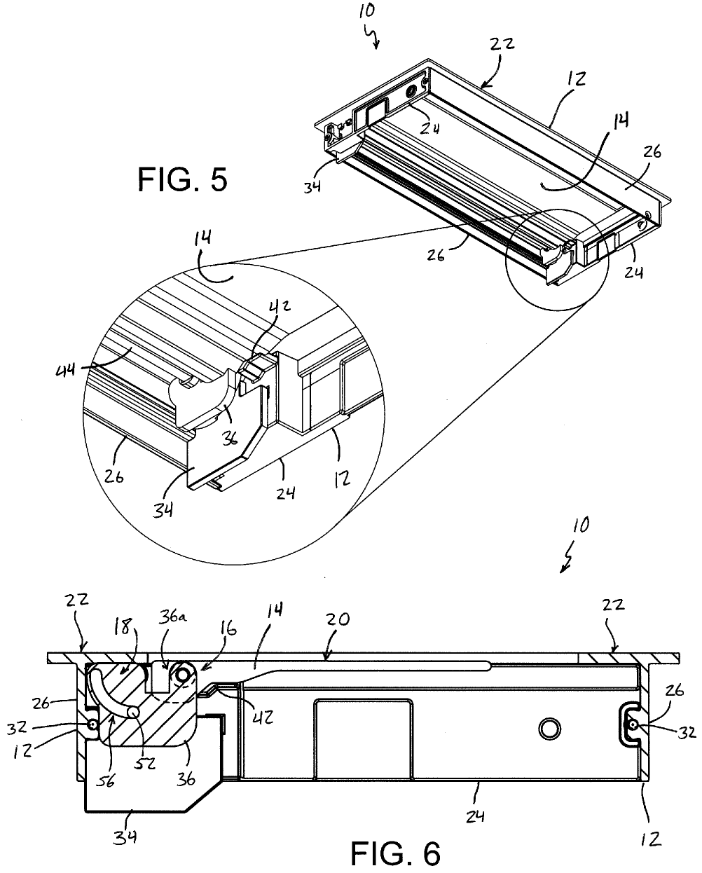

Second hinge portions 18 are formed by a first or outboard hinge piece 34 and a second or inboard hinge piece 36, with both hinge pieces 34, 36 at each side positioned directly beneath respective opposite end portions 14a, 14b of the lid 14, such as shown in FIG. 2. The hinge pieces 34, 36 are positioned adjacent one another and interact with one another and with either the lid 14 or the respective end wall 24, as will be described in more detail below. First hinge portions 16 are formed or established by a threaded fastener or a pin (not shown) that extends through a distal end portion 36a of the inboard hinge piece 36 and a corresponding bore 38 (FIG. 3) formed at each end portion 14a, 14b of the lid 14. A cutaway region 40 at the proximal end of the lid 14, at each end portion 14a, 14b, permits the lid's end portions 14a, 14b to overhang the respective distal end portions 36a of the inboard hinge piece 36. When lid 14 is coupled to the distal end portions 36a and the lid 14 is closed, the lid is pivotable upwardly about a first pivot axis defined through the bores 38 and the distal end portions 36a of the inboard hinge pieces 36, such as shown in FIGS. 6, 8, and 10, with no movement of the inboard hinge pieces 36 or the outboard hinge pieces 38. When lid 14 is resting in the closed position of FIGS. 1, 5 and 6, the end portions 14a, 14b of the lid rest atop respective pivot-stop elements 42 that project inwardly from inward-facing surfaces of the respective end walls 26, such as shown in FIG. 5.

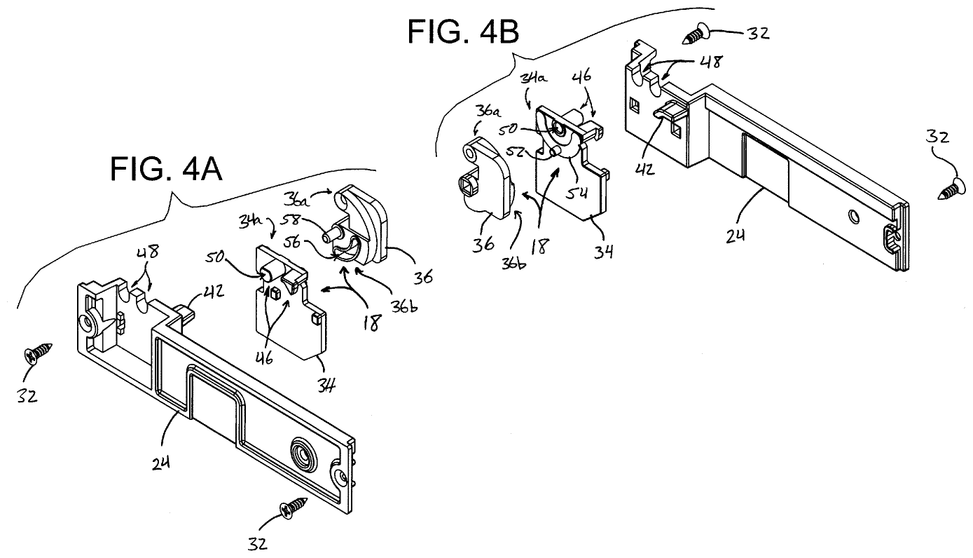

Second hinge portions 18 include an upper region 34a of each outboard hinge piece 34 and a proximal portion 36b of each inboard hinge piece 36, plus a crossbar 44 (FIG. 3) that extends between and coupled the inboard hinge pieces 36 together so that they pivot together during movement of the lid 14 from the vertically-raised position of FIG. 10 to the fully-open 180-degree position of FIG. 14. Outboard hinge pieces 34 are mounted via a snap-fit arrangement to the respective end walls 26, in which a pair of outboard-extending studs 46 are received in respective pairs of recesses 48 formed in the end walls 26 (FIGS. 4A and 4B). A pivot bore 50 is formed in each rearward stud 46 at the upper region 34a of each outboard hinge piece 34. A pivot guide stud 52 projects in an inboard direction from the upper region 34a of each outboard hinge piece 34, with guide studs 52 positioned directly below the respective pivot bores 50. Optionally, and as shown, a semi-circular bearing surface 54 extends below the pivot bore 50 at a fixed radius relative to the pivot bore, and is contacted by the corresponding inboard hinge piece 36. As best shown in FIG. 4B, the guide studs 52 extend from the lowest region of each semi-circular bearing surface 54.

The proximal portion 36b of each inboard hinge piece 36 defines an outboard-facing pivot channel 56 in the shape of a quarter-circular segment (FIG. 4A). Pivot channel 56 receives the respective guide stud 52, which traverses the channel 56 during pivoting movement of the lid 14 from the vertically-raised position of FIG. 10 to the fully-open 180-degree position of FIG. 14. As shown in FIG. 12, guide stud 52 is centered in the pivot channel 56 when lid 14 is in the 135-degree open position, whereas guide stud 52 contacts an end of the pivot channel 56 when the lid 14 is in the fully-open 180-degree position of FIG. 14, so that guide stud 52 prevents further pivoting movement of the lid 14 beyond the fully-open 180-degree position. As shown in FIG. 4A, the pivot channel 56 may be surrounded by an outboard-projecting lip that substantially matches the contour of the semi-circular bearing surface 54, and that slides along the semi-circular bearing surface 54 during pivoting movement of the second hinge portion 18, as can be understood with reference to FIGS. 12 and 14, and by comparing FIGS. 4A and 4B. The pivoting movement of the second hinge portion 18 is further constrained or guided by an outboard-extending pivot stud 58 at the proximal portion 36b of each inboard hinge piece 36 (FIG. 4A), which pivot stud 58 is pivotably received in a respective pivot bore 50 at the upper region 34a of each outboard hinge piece 34. It should be understood that pivot studs 58 and pivot bores 50 are not visible in FIG. 6, 8, 10, or 12 because the section views are taken through slightly different inboard regions of the inboard hinge piece 36, and not through the pivot stud 58 that is outboard of the section visible in those drawing figures. However, the location of the pivot stud 58 and its corresponding pivot bore 50 will be readily understood with reference to FIGS. 10, 12, and 14, with the understanding that the pivot stud 58 and pivot bore 50 are always positioned directly above the pivot guide stud 52.

The pivot axis of the second hinge portion 18 is defined centrally through the pivot studs 58 and pivot bores 50. The pivot axis of the first hinge portion 16 is spaced horizontally in front of the pivot axis of the second hinge portion 18 when the lid 14 is fully closed (FIG. 6) and typically remains fixed in that location when the lid 14 is pivoted to the vertical position of FIG. 10. As the lid 14 is pivoted further toward the 135-degree position of FIG. 12 and then the lay-flat 180-degree open position of FIG. 14, the pivot axis of the first hinge portion 16 begins to rise and pivot circumferentially upwardly and rearwardly until it is substantially directly above the pivot axis of the second hinge portion 18. From the fully closed position to the fully open position, the normal progression of pivoting movement of the lid 14 is first about the axis of the first hinge portion 16, and then about the axis of the second hinge portion 18, as described above. However, from the fully open position to the fully closed position, the lid 14 may pivot first about the pivot axis of the first hinge portion 16 and then about the pivot axis of the second hinge portion 18 once the lid 14 passes through the vertical position of FIG. 10 in the closing direction, or may pivot first about the pivot axis of the second hinge portion 18 and then about the pivot axis of the first hinge portion 16, or may pivot simultaneously about the pivot axes of the first and second hinge portions 16, 18 as the lid closes.

The order in which the lid 14 pivots about the two axes, or about the two axes simultaneously, depends on a combination of the frictional resistance to pivoting movement at each pivot axis, and also the direction of forces applied to the lid 14 including any torque that may be applied to the lid 14 by a user grasping the lid 14 during closing or opening. Thus, a user can force the lid 14 to pivot about the two axes at different times, during both opening and closing, so that the lid 14 will not always pivot first about the pivot axis of the first hinge portion 16 followed by pivoting second about the pivot axis of the second hinge portion 18.

Accordingly, the present invention provides a dual-hinged lay-flat lid that may be particularly well-suited for applications where the appearance of hinges when the lid is closed would be considered unsightly, and where it is desirable for the lid to lay in a flat, low-profile orientation while fully open. Such applications may include electrical and/or electronic data receptacle boxes that are recessed below work surfaces, or inserted into openings formed in work surfaces. The upper bezel portion may rest atop the work surface while the other electrical structure and housing portions are fully recessed below the work surface. The lid is easily opened by lifting it in an up-and-over movement, and may optionally be placed in an intermediate open position if desired.

Changes and modifications in the specifically-described embodiments may be carried out without departing from the principles of the present invention, which is intended to be limited only by the scope of the appended claims as interpreted according to the principles of patent law including the doctrine of equivalents.

The embodiments of the invention in which an exclusive property or privilege is claimed are defined as follows:

1. A dual-hinged lid assembly comprising:
a frame;
first and second hinge portions; and
a lid pivotably coupled to said frame via said first and second hinge portions, wherein said first hinge portion is pivotably coupled to said lid, and said second hinge portion is at said frame and is coupled to said first hinge portion; and
wherein said first hinge portion cooperates with said lid to define a first pivot axis, and said first hinge portion cooperates with said second hinge portion to define a second pivot axis spaced from said first pivot axis;
wherein said lid is pivotable from a closed position to an open position via pivoting movement about both of said first and second pivot axes.

2. The dual-hinged lid assembly of claim 1, further comprising a first hinge piece forming said first hinge portion and a second hinge piece forming said second hinge portion, wherein said second hinge piece is fixedly coupled to said frame.

3. The dual-hinged lid assembly of claim 2, wherein both said first hinge piece and said second hinge piece are positioned directly below a portion of said lid in the closed position.

4. The dual-hinged lid assembly of claim 1, wherein said first and second hinge portions are both covered by said lid in the closed position.

5. The dual-hinged lid assembly of claim 1, wherein said lid is pivotable about 180 degrees from the closed position to the open position.

6. The dual-hinged lid assembly of claim 5, wherein said lid is pivotable by about 90 degrees about said first pivot axis, said lid and said second hinge portion are pivotable together by about 90 degrees about said second pivot axis, and said first pivot axis is parallel to said second pivot axis.

7. The dual-hinged lid assembly of claim 1, wherein said second hinge portion comprises a pivot stud extending toward said first hinge portion and defines a pivot channel open toward said first hinge portion, wherein said first hinge portion comprises a pivot guide stud that is received in said pivot channel and a pivot bore that receives said pivot stud, and wherein said pivot guide stud traverses along said pivot channel as said second hinge portion pivots relative to said first hinge portion.

8. The dual-hinged lid assembly of claim 7, wherein said pivot stud and said pivot bore are disposed along said second pivot axis, and said pivot guide stud and said pivot channel are spaced radially away from said second pivot axis.

9. The dual-hinged lid assembly of claim 1, wherein one of said frame and said second hinge portion comprises a fixed pivot-stop element extending beneath said lid, wherein said lid rests atop said pivot-stop element in the closed position.

10. The dual-hinged lid assembly of claim 1, wherein said frame and said lid are configured to be secured to a housing that supports one or more electrical or data outlets.

11. A dual-hinged lid assembly comprising:
a frame defining an opening;
a lid pivotably coupled to said frame at said opening;
first and second hinge pieces coupled between said frame and said lid, wherein said first hinge piece is pivotably coupled to said lid and said second hinge piece is coupled between said first hinge piece and said frame; and
said first hinge piece cooperating with said lid to define a first pivot axis, and said first hinge piece cooperating with said second hinge piece to define a second pivot axis spaced from said first pivot axis;
wherein said lid is pivotable from a closed position to an open position via pivoting movement about both of said first and second pivot axes.

12. The dual-hinged lid assembly of claim 11, wherein said first and second hinge pieces are both covered by said lid in the closed position.

13. The dual-hinged lid assembly of claim 11, wherein said frame and said lid are configured to be secured to a housing that supports one or more electrical or data outlets.

14. The dual-hinged lid assembly of claim 11, wherein said lid is pivotable about 180 degrees from the closed position to the open position.

15. The dual-hinged lid assembly of claim 14, wherein said lid is pivotable by about 90 degrees about said first pivot axis, and wherein said lid and said second hinge piece are pivotable together by about 90 degrees about said second pivot axis.

16. The dual-hinged lid assembly of claim 11, wherein said second hinge piece comprises a pivot stud extending toward said first hinge piece and defines a pivot channel open toward said first hinge piece, wherein said first hinge piece comprises a pivot guide stud that is received in said pivot channel and a pivot bore that receives said pivot stud, and wherein said pivot guide stud traverses along said pivot channel as said second hinge piece pivots relative to said first hinge piece.

17. The dual-hinged lid assembly of claim 16, wherein said pivot stud and said pivot bore are disposed along said second pivot axis, and said pivot guide stud and said pivot channel are spaced radially away from said second pivot axis.

18. The dual-hinged lid assembly of claim 17, wherein said second hinge piece comprises a semi-circular bearing surface spaced from said pivot bore at a constant radius, wherein said first hinge piece is configured to slide along said bearing surface as said first hinge piece pivots relative to said first hinge piece.

19. The dual-hinged lid assembly of claim 11, wherein said first hinge piece remains fixed relative to said frame during the pivoting movement of said lid.

20. The dual-hinged lid assembly of claim 11, wherein one of said frame and said second hinge piece comprises a fixed pivot-stop element extending beneath said lid, wherein said lid rests atop said pivot-stop element in the closed position.
